(19) United States
(12) Patent Application Publication
(10) Pub. No.: US 2013/0223818 A1
(43) Pub. Date: Aug. 29, 2013

(54) METHOD AND APPARATUS FOR IMPLEMENTING A STORY

(71) Applicant: Damon Kyle Wayans, Thousand Oaks, CA (US)

(72) Inventor: Damon Kyle Wayans, Thousand Oaks, CA (US)

(21) Appl. No.: 13/781,153

(22) Filed: Feb. 28, 2013

Related U.S. Application Data
(60) Provisional application No. 61/604,727, filed on Feb. 29, 2012.

(51) Int. Cl. H04N 5/937

(52) U.S. Cl. CPC H04N 5/937
USPC 386/282

(57) ABSTRACT

Described herein is an interaction with a video game application using a computing device, and related technologies for implementing the video game application. In the video game application, the user controls a story and selects video segments to include in the story. The selection of the video segments may be governed to add difficulty in creating the story. Users may create video segment of different types to be used as the building video segments in creating the story.

### CROSS REFERENCE TO A RELATED APPLICATION

This application claims the benefit of U.S. patent application Ser. No. 61/604,727 entitled METHOD AND APPARATUS FOR IMPLEMENTING A NEVER ENDING STORY, filed Feb. 29, 2012, which application is incorporated by reference as if fully set forth.

### FIELD OF INVENTION

The present invention relates to a method and apparatus for implementing a story, and in particular, to a method and apparatus for implementing a story using video segments.

### BACKGROUND

In recent years, technologies for implementing electronic games have become very popular. Technology has increased to where a personal computing device has the necessary computing power to manage and manipulate video. The power of video has grown exponentially with YouTube and other online video repositories. Many aspects of the video medium make the medium interesting and engaging—such as the interplay that exists in video between audio and visual images. Therefore, new approaches to manipulating and managing video and combining video segments together, such as the approaches described in detail below, would be advantageous.

### SUMMARY

A computing device for creating a video story based on input from a user is disclosed. The computing device includes a memory device configured to store data that represents a plurality of video data segments that make up a video and data that indicates an ordered sequence of the video data segments in the video; the video data segments are classified according to the type of video data segment. The computing device also includes a processor configured to display, via a display device, a video display area that includes information related to the video segments, and to receive, via an input device, user input data from the user, wherein the user input data indicates positions of the video data segments in the sequence; to update results data to include a story that is the video data segments appended in the selected order based on the position in the sequence of the video data segment to which the source video data segment icon corresponds. Further, the computing device includes a communication interface to output the story.

A method for creating a story based on input from a user is also disclosed. The method includes: storing video data in a memory device, wherein the video data includes a plurality of video data segments that make up a video, wherein each of the video data segments includes a plurality of frames and corresponding audio data, the video data segments classified according to the type of video data segment, and data that indicates a relationship based on the type of video segments in the story, wherein each of the video data segments has a position in the sequence. The method further includes storing the story results data in the memory device, wherein the story results data includes a story that is the video data segments appended in a selected order; displaying, via a display device, a video display area, wherein the video display area includes: a plurality of video data segment icons, wherein each of the video data segment icons corresponds to a video data segment of the video data segments, and wherein each of the video data segment icons includes a frame from the video data segment to which the video data segment icon corresponds and a plurality of sequence position icons, wherein each of the sequence position icons corresponds to a position in the sequence. Further, the method includes receiving user input data from the user via an input device, wherein the user input data includes a plurality of drag and drop operations, wherein each of the drag and drop operations indicates a drag and drop operation from a source video data segment icon of the video data segment icons onto a target sequence position icon of the sequence position icons; for each of the drag and drop operations, determining whether the position in the sequence of the video data segment to which the source video data segment icon corresponds is the same as the position in the sequence to which the target sequence position icon corresponds, and when the position in the sequence of the video data segment to which the source video data segment icon corresponds is the same as the position in the sequence to which the target sequence position icon corresponds, updating the results data to include a story that is the video data segments appended in the selected order based on the position in the sequence of the video data segment to which the source video data segment icon corresponds; and outputting the story.

The computer-readable medium having processor-executable instructions stored thereon which, when executed by at least one processor, will cause the at least one processor to perform a method for creating a story based on input from a user. The method includes storing video data in a memory device, wherein the video data includes a plurality of video data segments that make up a video, wherein each of the video data segments includes a plurality of frames and corresponding audio data, the video data segments classified according to the type of video data segment, and data that indicates a relationship based on the type of video segments in the story, wherein each of the video data segments has a position in the sequence; and storing the story results data in the memory device, wherein the story results data includes a story that is the video data segments appended in a selected order. The method further includes displaying, via a display device, a video display area, wherein the video display area includes: a plurality of video data segment icons, wherein each of the video data segment icons corresponds to a video data segment of the video data segments, and wherein each of the video data segment icons includes a frame from the video data segment to which the video data segment icon corresponds, and a plurality of sequence position icons, wherein each of the sequence position icons corresponds to a position in the sequence. Also, the method includes receiving user input data from the user via an input device, wherein the user input data includes a plurality of drag and drop operations, wherein each of the drag and drop operations indicates a drag and drop operation from a source video data segment icon of the video data segment icons onto a target sequence position icon of the sequence position icons, for each of the drag and drop operations; and determining whether the position in the sequence of the video data segment to which the source video data segment icon corresponds is the same as the position in the sequence to which the target sequence position icon corresponds. When the position in the sequence of the video data segment to which the source video data segment icon corresponds is the same as the position in the sequence to which the target sequence position icon corresponds, updating the results data to include a story that is the video data segments appended in the selected order based on the position in the sequence of the video data segment to which the source video data segment icon corresponds. The method includes outputting the story.

The method may also include displaying, via the display device, the story and/or receiving a second user input data that indicates that a video data segment icon of the video data segment icons has been selected to be filled by a certain type of video data segment, and in response to the second user input data, allowing the selected type of video data segment to fill the position in the sequence to which the selected video data segment icon corresponds.

### BRIEF DESCRIPTION OF THE DRAWINGS

Understanding of the present invention will be facilitated by consideration of the following detailed description of the preferred embodiments of the present invention taken in conjunction with the accompanying drawings, in which like numerals refer to like parts:

FIG. 1 illustrates a main window where data is displayed by the video application;

FIG. 2 illustrates the main window presenting different types of video data segment icons available in the video application;

FIG. 3 illustrates the building of individual video segments to be used in the application;

FIG. 4 illustrates a display of the story application as described herein;

FIG. 5 illustrates a method used for creating an ADVERTISING video segment;

FIG. 6 illustrates a method used for creating a PLAYER video segment;

FIG. 7 illustrates a method used for creating a STAR video segment;

FIG. 8 is a video segment diagram of a computing device that may be used to implement features described herein; and

FIG. 9 illustrates an example architecture wherein features described herein may be implemented.

### DETAILED DESCRIPTION OF THE EMBODIMENTS

It is to be understood that the figures and descriptions of the present disclosure have been simplified to illustrate elements that are relevant for a clear understanding of the present disclosure, while eliminating, for the purpose of clarity, many other elements found in mobile applications and other computer content generators and programs. Those of ordinary skill in the art may recognize that other elements and/or steps are desirable and/or required in implementing the present disclosure. However, because such elements and steps are well known in the art, and because they do not facilitate a better understanding of the present disclosure, a discussion of such elements and steps is not provided herein. The disclosure herein is directed to all such variations and modifications to such elements and methods known to those skilled in the art.

Described herein is an interaction with a video game application using a computing device, and related technologies for implementing the video game application. In the video game application, the user controls a story and selects video segments to include in the story. The selection of the video segments may be governed to add difficulty in creating the story. Users may create video segments of different types to be used as the building video segments in creating a story.

As used herein, the terms “video” and “video data” refer to electronic data that represents a sequence of images. The sequential images in a video are referred to herein as “frames.” Each image in a video may be a raster of pixels that has a width and a height. A video may also include audio data. A video may have characteristics such as a frame rate (which is the rate at which frames in the video are displayed, and which is frequently indicated as Frames Per Second (FPS)), and other characteristics. As used herein, the term “video data segment” refers to the data that makes up a portion of a video. For example, if a video is made up of 10,000 frames and corresponding audio, a video data segment that makes up the first half of video would include the first 5000 frames, the audio data that corresponds to the first 5000 frames and possibly additional information associated with the first 5000 frames.

The present description provides a system in which a user appends video segments together to make a story. The individual video segments may include different categories of video segments, and requirements for the use of certain types of video segments may need to be met in building the story. Additionally, a game may be played where the structure, such as order and relationships between video segment types, may be included. Methods of creating video segments are also described. The methods include variations for creating different types of video segments contemplated in the present description.

A set of sequence icons identifying positions for video segments within the story may be provided. The various video segments that may be used in the story may be represented in the application as video segment icons. The video segment icons may be manipulated over the set of sequence icons to be placed in the story in an identified order as represented by the position of the sequence icon within the set of sequence icons that the video segment icon is manipulated over.

A computing device for creating a video story based on input from a user is disclosed. The computing device includes: a memory device configured to store data that represents a plurality of video data segments that make up a video and data that indicates an ordered sequence of the video data segments in the video, the video data segments classified according to the type of video data segment; a processor configured to display, via a display device, a video display area that includes information related to the video segments, and to receive, via an input device, user input data from the user, wherein the user input data indicates positions of the video data segments in the sequence, and to update results data to include a story that is the video data segments appended in the selected order based on the position in the sequence of the video data segment to which the source video data segment icon corresponds; and a communication interface to output the story.

A method for creating a story based on input from a user is also disclosed. The method includes: storing video data in a memory device, wherein the video data includes a plurality of video data segments that make up a video, wherein each of the video data segments includes a plurality of frames and corresponding audio data, the video data segments classified according to the type of video data segment, and data that indicates a relationship based on the type of video segments in the story, wherein each of the video data segments has a position in the sequence. The method further includes storing the story results data in the memory device, wherein the story results data includes a story that is the video data segments appended in a selected order; displaying, via a display device, a video display area, wherein the video display area includes: a plurality of video data segment icons, wherein each of the video data segment icons corresponds to a video data segment of the video data segments, and wherein each of the video data segment icons includes a frame from the video data segment to which the video data segment icon corresponds and a plurality of sequence position icons, wherein each of the sequence position icons corresponds to a position in the sequence. Further, the method includes receiving user input data from the user via an input device, wherein the user input data includes a plurality of drag and drop operations, wherein each of the drag and drop operations indicates a drag and drop operation from a source video data segment icon of the video data segment icons onto a target sequence position icon of the sequence position icons; for each of the drag and drop operations, determining whether the position in the sequence of the video data segment to which the source video data segment icon corresponds is the same as the position in the sequence to which the target sequence position icon corresponds, and when the position in the sequence of the video data segment to which the source video data segment icon corresponds is the same as the position in the sequence to which the target sequence position icon corresponds, updating the results data to include a story that is the video data segments appended in the selected order based on the position in the sequence of the video data segment to which the source video data segment icon corresponds; and outputting the story.

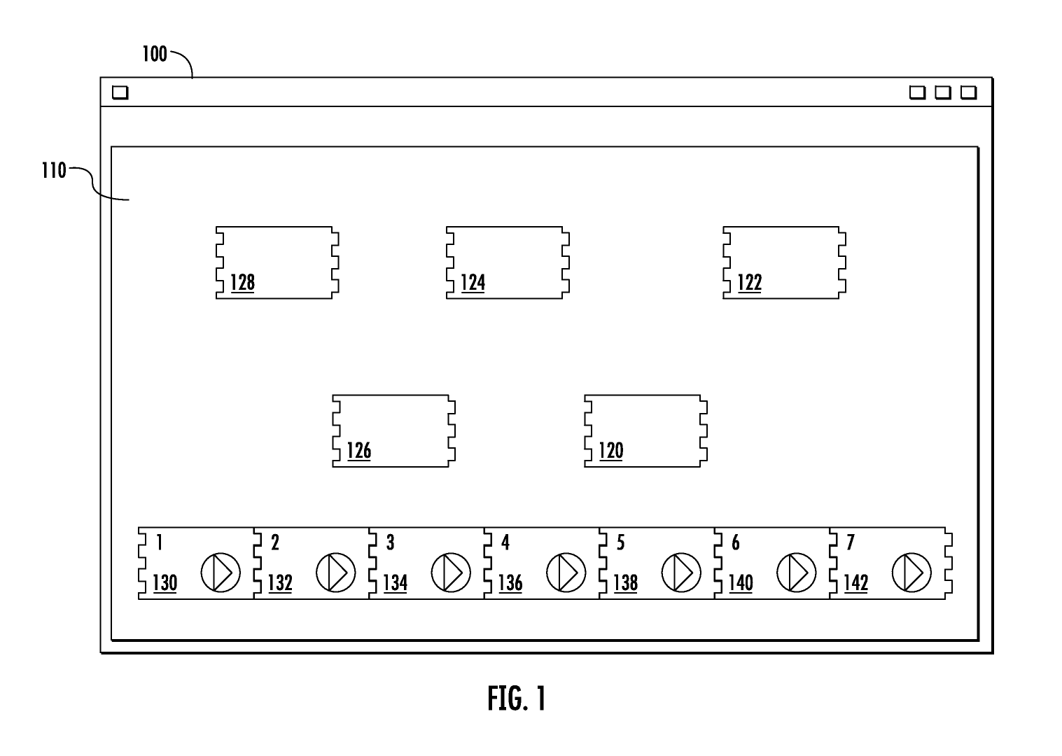

FIG. 1 illustrates a main window 100 including data displayed by the video application. This main window 100 is displayed by the video application at startup, as well as at other times during the operation of the video application. The main window 100 includes a video information area 110 which contains information related to at least one story. The information area 110 relates to a “Drag and Drop” story. Within the information area 110 there is shown a number of icons that are used in creating the story.

As shown in FIG. 1, information area 110 includes five randomly placed video data segment icons 120, 122, 124, 126, 128, each of which corresponds to one of the video data segments, and each of which is shaped like a puzzle piece or a frame on a strip of film. That is, video data segment icons 120, 122, 124, 126, 128 each are an on-screen graphical representation that represents an associated video data segment, such that when the icon is activated, the associated video segment may be activated. Video data segment icons 120, 122, 124, 126, 128 are icons that represent video segments that are provided for a user to select in building a story. Users may build a story from the compilation of video segments represented by video data segment icons 120, 122, 124, 126, 128. For example, five-second video segments may be used as the building video segments in creating a story. That is, each of the video data segment icons 120, 122, 124, 126, 128 may represent a five-second video segments that may be selected in creating the story.

FIG. 1 further illustrates sequence position icons 130, 132, 134, 136, 138, 140, 142 for the placement of video data segments. Sequence position icons 130, 132, 134, 136, 138, 140, 142 represent positions in a sequence that may be filled with the video segments. Selection by a user of one of the video data segment icons (representing the associated video segment) to place in one of the sequence position icons (the position in the sequence) may add that respective video segment to the sequence of video segments in the selected position as represented by the chosen sequence position icon. Once selected for inclusion in the sequence of video segments at a selected position in the sequence, the selected video segment icon (representing the associated video segment) may be replaced by a new video segment icon representing a different video segment. Alternatively, a larger number of video data segment icons may be presented, and the user may select and order the video segment icons in place of the segment position icons until each of the displayed video data segment icons are used.

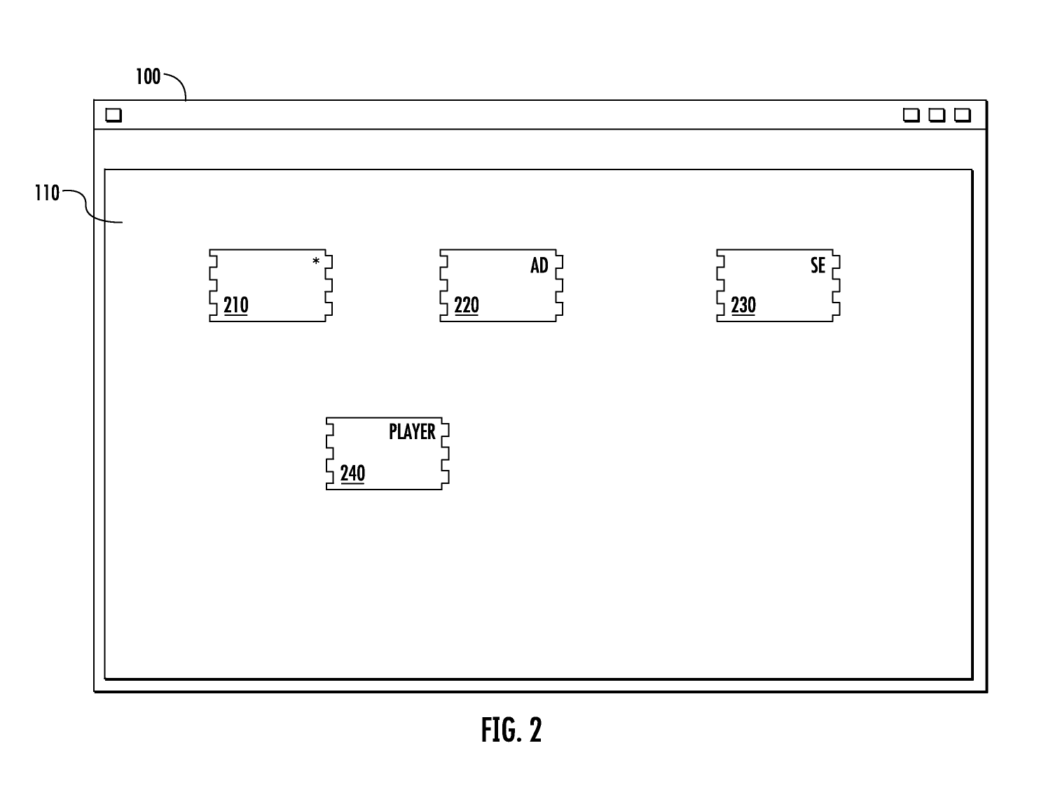

FIG. 2 illustrates the main window 100 presenting different types of video data segment icons. The different types of video segment icons represent the underlying video segments. The video segments are of different types and the different types of video segments may be combined to form the story. Specifically, the story may utilize a STAR video segment as represented by the STAR video segment icon 210, an ADVERTISING video segment as represented by the ADVERTISING video segment icon 220, a SPECIAL EFFECTS video segment as represented by the SPECIAL EFFECTS video segment icon 230, and a PLAYER video segment as represented by the PLAYER video segment icon 240. Multiple ones of each type of video segment icons 210, 220, 230, 240 may be displayed. Alternatively, a set amount of each type of video segment icons 210, 220, 230, 240 may be displayed in the main window during creation of the story. This set amount of icons 210, 220, 230, 240 may include 2, 5, or 10 icons displayed of each type. This set amount may be different for each of the different types of video segment icons 210, 220, 230, 240, such as five PLAYER icons 240, one SPECIAL EFFECTS icon 230, two ADVERTISING icons 220, and three STAR icons 210. The amount of any one particular type of video segment icon 210, 220, 230, 240 may vary as desired.

By way of non-limiting example only, there may be at least three distinct types of video segments. A STAR video segment, represented by STAR video segment icon 210, may include video segments that have been produced within the present application using the associated architecture. PLAYER video segments, represented by PLAYER video segment icon 240, may include original video of a user. ADVERTISING video segments, represented by ADVERTISING video segment icon 220, may include video segments of video that are recorded following a script or template. Users may also be able to add video segments generated by users within the application to the story. The application may be configured such that every time that a video segment created by a user is used in a story, the creating user may receive points within the application, or some other commodity valuable in the application or otherwise. These points may allow the user to acquire assets, such as special video segments, including STAR video segments, SPECIAL EFFECTS video segments, or the like. Points may also be used to acquire goodies offered by sponsors or virtual coupons, for example. In building a story, a user may need to alternate the individual composite video segments types to create the story.

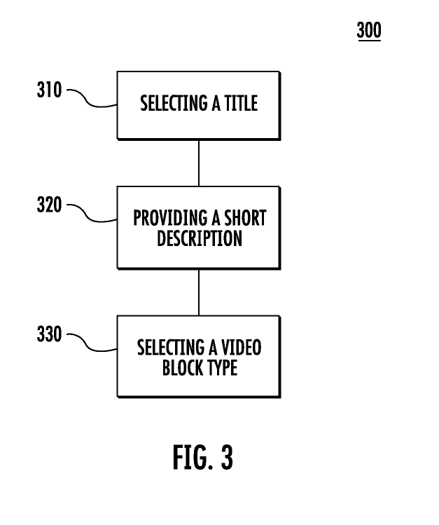

The building of the story may be initiated by building individual video segments to be used in the story as illustrated in FIG. 3. A method 300 of building individual video segments for the story may include a user selecting a title of the video segment at step 310, providing a short description of the video segment contents at step 320, and selecting the type video segment to be created at step 330, such as a STAR or ADVERTISING video segment, for example. Other information may be included, and some additional or alternative information may be provided in place of the information described above as long as the created video segment is described and understood by viewing the information.

Stories may be edited. Video segments may be locked and uneditable. Users may share sections of a story and/or the associated video using bookmarks or some other marking function that allows for tabbing video segments. User points in the present application may be accumulated when a story is shared by any user. The present application may be configured so that only the author of the story may edit the story.

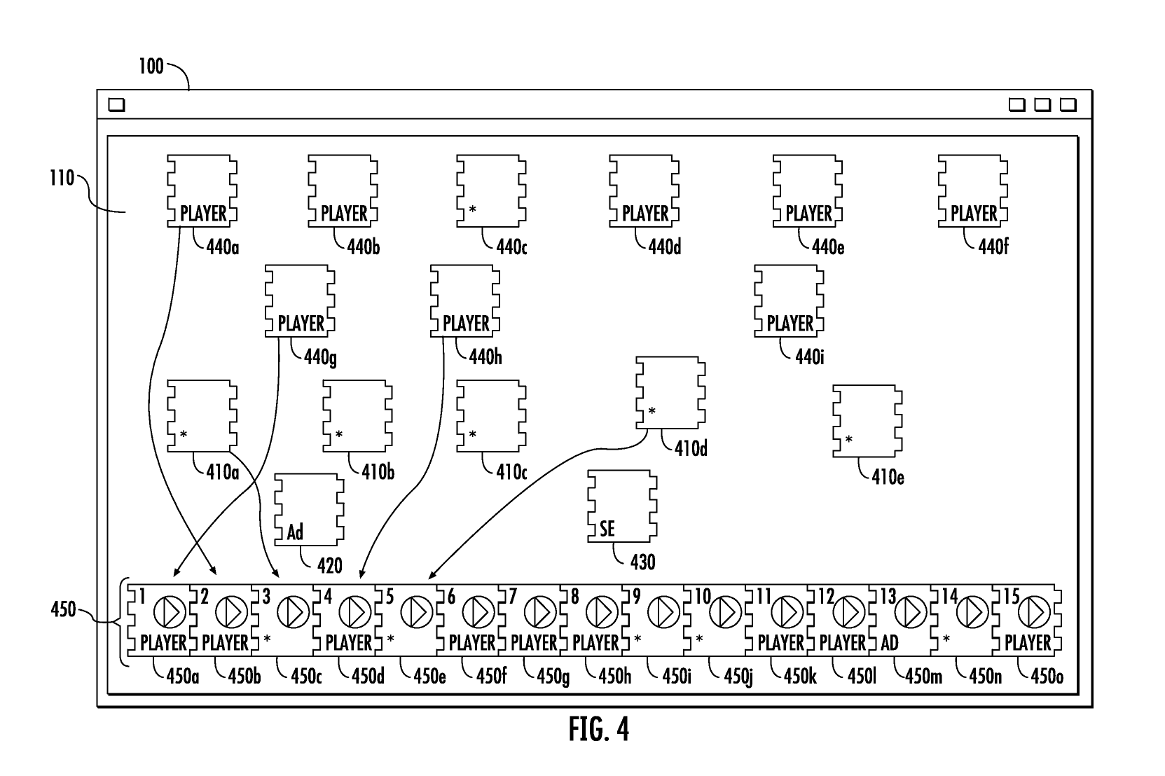

FIG. 4 illustrates a display of the application used for building the video story as described herein. Using the video segments of FIG. 2 through their respective icons, a user may create a story by applying the icons (and therefore the associated video segments) in a specific or certain order. As illustrated in FIG. 4, a myriad, such as one or more, of different PLAYER video segments, collectively referred to as PLAYER video segments 440, may be provided in the main window 100. A myriad of different STAR video segments 410, ADVERTISING video segments 420, and SPECIAL EFFECTS video segments 430 may also be provided. As shown there are nine PLAYER video segments 440, identified individually as PLAYER video segment 440a-i; five STAR video segments 410, identified individually as STAR video segment 410a-e; one ADVERTISING video segment 420; and one SPECIAL EFFECTS video segment 430, by way of example only.

Once the application is started, a user may fill the video spots represented by the video segment icons, collectively video segment icons 450, individually denoted as video segment icons 450a-o by sequentially moving ones of video segments 410, 420, 430, 440 to video segment icons 450, such as by “drag and drop.” This allows the video segments 410, 420, 430, 440 to be placed in order and allows the content of one video segment to play sequentially with the content of the next video segment.

Different configurations of the video segments 410, 420, 430, 440 may be created. The application may remove the user's ability to select certain of the video segments 410, 420, 430, 440 in certain situations. For example, the application may force alternating or patterned building of the video segments 410, 420, 430, 440; in other words, no video segment 410, 420, 430, 440 may be placed adjacent to the same type of video segment.

Other combinations of video segments 410, 420, 430, 440 may also be required by the application. According to one example, the application may require that the user have the following relationship in building the video segments 410, 420, 430, 440: for every two PLAYER video segments 440, a STAR video segment 410 must be used, and after using any twelve video segments, an ADVERTISING video segment 420 must be used. SPECIAL EFFECTS video segments 430 may be used at the user's discretion, for example. Certainly other configurations of video segments may be used and these combinations will be left to the imagination of the users.

In FIG. 4, the story is built with the video segments 410, 420, 430, 440. The video segment icons 450 may be used to represent the type of video segment 410, 420, 430, 440 that is required by the application to be placed in the video segment icons position, and/or may display the type of video segment a user selected to place in the video segment icons. That is, the snapshot of the application depicted in FIG. 4 may represent the application prior to a user selecting video segments 410, 420, 430, 440 to place on video segment icons 450, after a user has selected video segments 410, 420, 430, 440 to place on video segment icons 450, or a point during the process where a user has selected some video segments 410, 420, 430, 440 to place on video segment icons 450 and the application has then selected the type of video segment icons 450 prior to a user selecting video segments 410, 420, 430, 440 to place on those video segment icons 450.

For the case where the snapshot of the application depicted in FIG. 4 represents the application prior to a user selecting video segments 410, 420, 430, 440 to place on video segment icons 450, the video segment icons 450 may be distributed in a randomly selected order by the application. Based on the presented video segments 410, 420, 430, 440, a user may then build a story by matching the presented video segments 410, 420, 430, 440 with the matching randomly selected order of the video segment icons 450. In this configuration, the application selects video segment icon 450a to require filling by a PLAYER video segment. The user may select to fill video segment icon 450a with any one of the available PLAYER video segments 440a-440i. In this case, the user select to fill video segment icon 450a with PLAYER video segment 440g.

A similar selection may occur for video segment icon 450b. In filling this icon, the user may select a PLAYER video segment (as identified by the video segment icon 450b) from the available PLAYER video segments 440a-f, h-i, since PLAYER video segment 440g has been already used to fill video segment icon 450a PLAYER video segment 440g is unavailable for filling icon 450b. This pattern may continue as the various video segment icons 450 are filled. Although the discussion has focused on filling the video segment icons 450 from left to right, any available order may be chosen including right to left, alternating, and random for example. That is, the video segment icons 450 may be filled in a predefined order and/or in an order selected by the user or application.

For the case where the snapshot of the application depicted in FIG. 4 is after a user has selected video segments 410, 420, 430, 440 to place on video segment icons 450, a user may select the placement of video segments 410, 420, 430, 440 to place on given video segment icons 450. The user may be guided, or limited, in the options available in placing video segments 410, 420, 430, 440 on given video segment icons 450. For example, different combinations of video segments 410, 420, 430, 440 may be required as described above, and within a framework of different combinations, a user may be free to select any video segment of a given video segment 410, 420, 430, 440 type as required.

A combination of video segment icon 450 filing may also occur. That is, a user may be free to select the first icons 450 to fill up to a predefined amount of icons 450 or percentage of the icons 450, for example, at which point the application then preselects the type of video segments 410, 420, 430, 440 to fill the remaining unfilled icons 450 or the application may first preselect the type of video segments 410, 420, 430, 440 to fill the icons 450, and once a user works within that preselected framework to select icons 450 to fill up to a predefined amount of icons 450 or a percentage of the icons 450, the pre-selection of the type of video segments 410, 420, 430, 440 is eliminated and the user is free to fill in the icons 450 with their selection of video segments 410, 420, 430, 440 type. While these options demonstrate a completely pre-selection or open selection environment, further combinations of the two options are also contemplated. For example, the application may select that only certain of the icons 450 are preselected for a certain type of video segments 410, 420, 430, 440, while the other icons 450 remain user-selectable. A gradual conversion from pre-selection to user-selectable or vice versa may also occur.

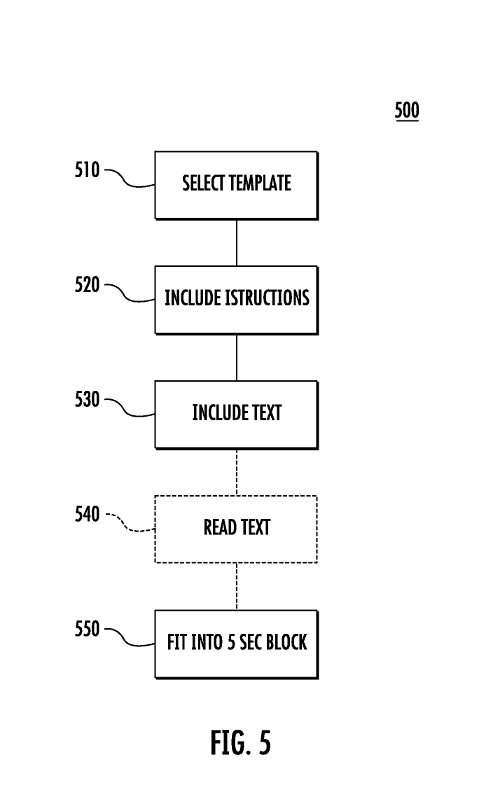

FIG. 5 illustrates a method 500 used for creating an ADVERTISING video segment. ADVERTISING video segments, represented by ADVERTISING video segment icon (220 in FIG. 2), may include video segments of video that are recorded following a script or template. At step 510, method enables a user to select a template, such as from ADVERTISING script library, for example. Instructions may be included within the template at step 520. Text also may be included in the template at step 530. The template including any instructions and text may be used to create the ADVERTISING video segment. Creation of the video segment may require a user to read the text at step 540. At step 550, a challenge may be created in fitting the text into a five second video segment, for example, which may add to the increased enjoyment of the application. Once created the ADVERTISING video segment may be added to a library for use in the story application.

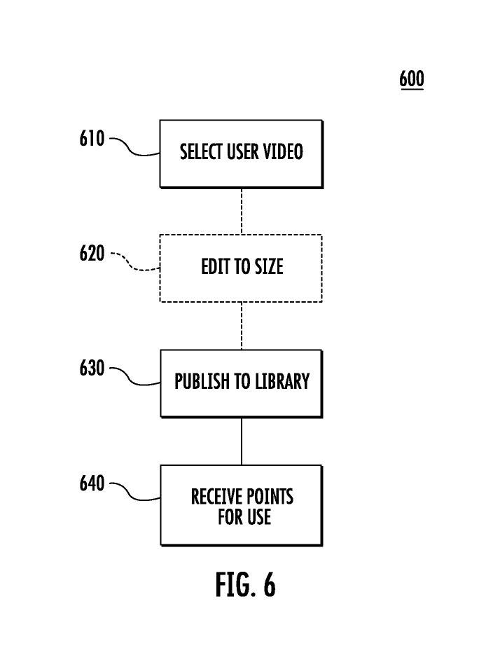

FIG. 6 illustrates a method 600 used for creating a PLAYER video segment. PLAYER video segments, represented by PLAYER video segment icon (240 in FIG. 2), may include original video of a user. Method 600 includes a user selecting a user video at step 610. This user video may be stored on a computing device that the user has access to, is using, or may be found remotely and downloaded, for example. Once a user selects a user video, the selected user video may be edited to size at step 620. This optional editing may force a video segment to be fit to size as required within the present application. Once the video is selected and optionally edited for size, a user may publish the video segment to the library at step 630. This publishing creates a PLAYER video segment. At user who has created a PLAYER video segment may receive points for the use of that PLAYER bock at step 640.

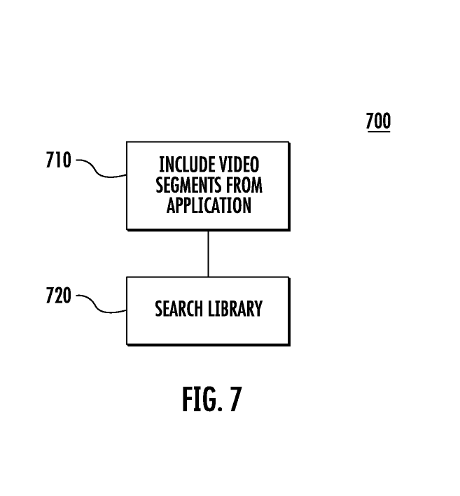

FIG. 7 illustrates a method 700 used for creating a STAR video segment. A STAR video segment, represented by STAR video segment icon (210 in FIG. 2), may include video segments that have been produced within the present application using the associated architecture. Method 700 includes the user or the application including video segments previously used in the application at step 710. These video segments may be located by searching a library of STAR video segments at step 720. Such a search may include searching by topic, actor, words, and the like, for example. Once created the STAR video segment may be added to a library for use in the story application.

SPECIAL EFFECTS video segments may be created by users and posted for other users to acquire using points that have been earned to within the application. The SPECIAL EFFECTS video segments may provide enhanced features or other additional bells and whistles to the story produced by a user.

Each video segment icon may include a “play” button that allows the contents of the video segment to be viewed. The video application may be played like a game. In this regard, the recording of a video segment cannot be stopped once it has been started. Once the video segment recording is completed, the video segment is published in the library automatically and is set so that all viewers of the library may see and use the video segment. Video segments may be rated by users and comments on a video segment may be provided.

After the video story is created, the user may use the video application to upload the video to a social networking site or other type of web site, such as Facebook, YouTube, or any other web site. Alternatively or additionally, after the video is created, the user may use the video application to save the created video to a local hard drive or other data storage device.

Although a number of examples are provided above wherein videos are divided into segments, the number presented was chosen purely by way of example. The video application described herein may operate with videos that are divided into any number of video data segments. Additionally, the video data segments may be of any duration.

The videos that may be used with the video application include videos any type of content. For example, videos that may be used with the video application include music videos, full feature-length films, documentary videos, commercial videos, homemade/amateur videos, and/or other types of videos.

The video application described herein may be used with video of any type of format. For example, the video application may be used with videos that are formatted according to formats such as but not limited to: H.264 (MPEG); H.263; H.262 Windows Media Video (WMV); Quicktime; and/or any other appropriate format.

The video application described herein may be implemented as a stand-alone executable, as a web application, as a rich Internet application, and/or as any other appropriate type of application. The video application may be implemented using technologies that include modern programming languages such as C and/or C++, a development framework such as Adobe Air, and/or any other appropriate technology.

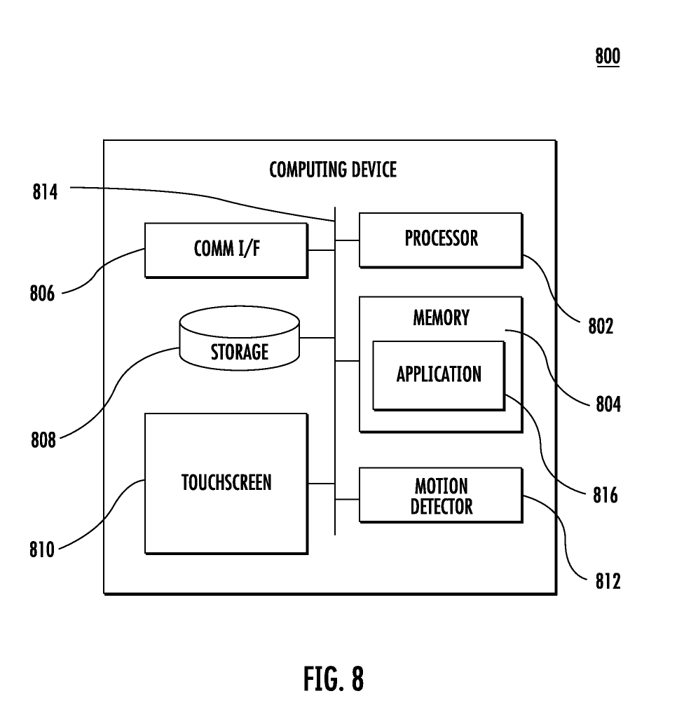

FIG. 8 is a video segment diagram of a computing device 800 that may be used to implement features described herein. The computing device 800 includes a processor 802, a memory device 804, a communication interface 806, a data storage device 808, a touchscreen display 810, and a motion detector 812. These components may be connected via a system bus 814 in the computing device 800, and/or via other appropriate interfaces within the computing device 800.

Using the computing device 800, a user may connect to the application. Computing device 800 acts as a game remote in a similar fashion to a game console. Users may use a computing device 800 as the maneuvering devices to accumulate and append video segments together.

The memory device 804 may be or include a device such as a Dynamic Random Access Memory (D-RAM), Static RAM (S-RAM), or other RAM or a flash memory. As shown in FIG. 8, the application 816 may be loaded into the memory device 804.

The data storage device 808 may be or include a hard disk, a magneto-optical medium, an optical medium such as a CD-ROM, a digital versatile disk (DVDs), or Blu-Ray disc (BD), or other type of device for electronic data storage. The data storage device 808 may store instructions that define the application 816, and/or data that is used by the application 816.

The communication interface 806 may be, for example, a communications port, a wired transceiver, a wireless transceiver, and/or a network card. The communication interface 806 may be capable of communicating using technologies such as Ethernet, fiber optics, microwave, xDSL (Digital Subscriber Line), Wireless Local Area Network (WLAN) technology, wireless cellular technology, and/or any other appropriate technology.

The touchscreen display 810 may be based on one or more technologies such as resistive touchscreen technology, surface acoustic wave technology, surface capacitive technology, projected capacitive technology, and/or any other appropriate touchscreen technology.

The motion detector 812 may include one or more three-axes acceleration motion detectors (e.g., accelerometers) operative to detect linear acceleration in three directions (i.e., the X (left/right) direction, the Y (up/down) direction, and the Z (out of plane) direction). Alternatively, the motion detector 812 can include one or more two-axis acceleration motion detectors 812 which can be operative to detect linear acceleration only along each of the X or Y directions, or any other pair of directions. Alternatively or additionally, the motion detector 812 may be or include an electrostatic capacitance accelerometer that is based on a technology such as silicon micro-machined MEMS (Micro Electro Mechanical Systems) technology, a piezoelectric type accelerometer, a piezoresistance type accelerometer, or any other suitable type of accelerometer.

When the touchscreen 810 receives data that indicates user input, the touchscreen 810 may provide the data to the application 816. Alternatively or additionally, when the motion detector 812 detects motion, the motion detector 812 may provide the corresponding motion information to the application 816.

As shown in FIG. 8, the application 816 is loaded into the memory device 804. Although actions are described herein as being performed by the application 816, this is done for ease of description and it should be understood that these actions are actually performed by the processor 802 (in conjunction with the persistent storage device, network interface, memory, and/or peripheral device interface) in the computing device 800, according to instructions defined in the application 816. Alternatively or additionally, the memory device 804 and/or the data storage device 808 in the computing device 800 may store instructions which, when executed by the processor 802, cause the processor 802 to perform any feature or any combination of features described above as performed by the application 816. Alternatively or additionally, the memory device 804 and/or the data storage device 808 in the computing device 800 may store instructions which, when executed by the processor 802, cause the processor 802 to perform (in conjunction with the memory device, communication interface, data storage device, touchscreen display, and/or motion detector) any feature or any combination of features described above as performed by the application 816.

The computing device 800 shown in FIG. 8 may be, for example, an Apple iPad, or any other appropriate computing device. The application 816 may run on an operating system such as iOS, Android, Linux, Windows, and/or any other appropriate operating system.

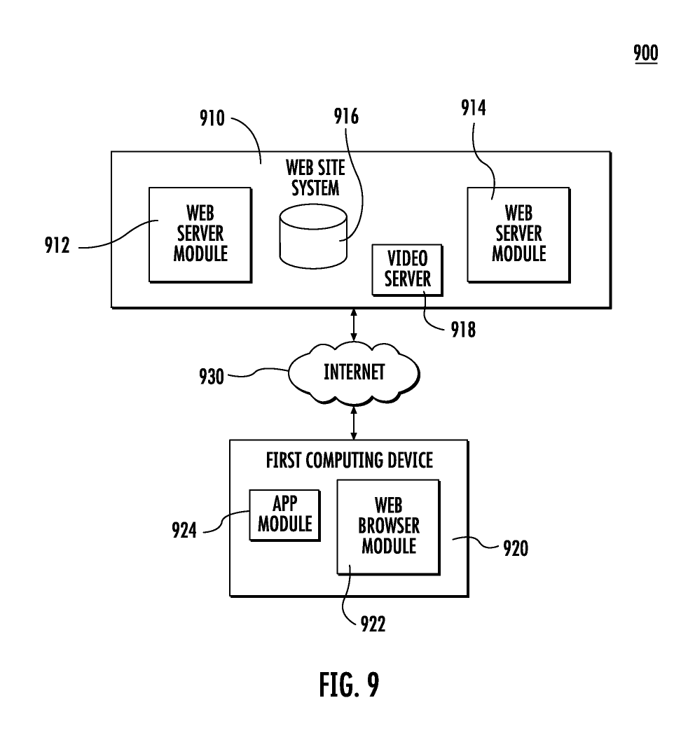

FIG. 9 illustrates an example architecture 900 wherein features described herein may be implemented. The example architecture 900 includes a web site system 910, a computing device 920, and the Internet 930. The web site system 910 of FIG. 9 includes hardware (such as one or more server computers) and software for implementing an application as described. The computing device 920 described above may be used to download and run a local application to interact with other applications and/or software to allow the transfer of information. Alternatively, an end user may use the computing device 920 to display and interact with the web pages that make up the interactive web site. The device 920 shown in FIG. 9 may be, for example, a laptop or desktop computer, a tablet computer, a smartphone, a PDA, and/or any other appropriate type of device.

The web site system 910 includes a web server module 912, a web application module 914, a database 916, and a video server 918, which, in combination, store and process data for providing the web site. The web application module 914 may provide the logic behind the web site provided by the web site system 910, and/or perform functionality related to the generation of the web pages provided by the web site system 910. The web application 914 may communicate with the web server module 912 for generating and serving the web pages that make up the web site.

Video server 918 may be a computer based device, such as a host, dedicated to delivering video. Video server 918 may be designed for one purpose; provisioning video. Video server 918 may perform recording, storage, and playout of multiple video streams without any degradation of the video signal. Video server 918 may store hundreds of hours of compressed audio and video (in different codecs), play out multiple and synchronized simultaneous streams of video by, and offer quality interfaces such as SDI for digital video and XLR for balanced analog audio, AES/EBU digital audio and also Time Code. Video server 918 may provide a means of synchronizing with the house reference clock, such as a genlock input, to avoid the need for timebase correction or Frame synchronizers. Video server 918 may offer a control interface allowing video server 918 to be driven by broadcast automation systems that incorporate sophisticated broadcast programming applications including protocols such as VDCP and the 9-Pin Protocol. Video server 918 may allow direct to disk recording using the same codec that is used in various post-production video editing software packages to prevent any wasted time in transcoding.

The computing device 920 may include a web browser module 922, which may receive, display, and interact with the web pages provided by the web site system 910. The web browser module 922 in the computing device 920 may be, for example, a web browser program such as Internet Explorer, Firefox, Opera, Safari, and/or any other appropriate web browser program. To provide the web site to the user of the computing device 920, the web browser module 922 in the computing device 920 and the web server module 912 may exchange HyperText Transfer Protocol (HTTP) messages, per current approaches that would be familiar to a skilled person.

The application module 924 may provide the logic behind the computing device and interaction provided by the web browser module 922, and/or performs functionality related to the generation of the web pages provided by the web browser module 922. The application module 924 may communicate with the web browser module 922 for generating and serving the web pages that make up the web site.

As described hereinabove, details regarding the interactive web site and the pages of the web site (as generated by the web site system 910 and displayed/interacted with by the user of the computing device 920) are provided.

Registration to the site may be required in order to interact using the computing device 920. Users can create an account with the web site, and/or may log in via credentials associated with other web sites. With each user account, the user has a personal page. Via this page, users can establish “friends” links to other users, transmit/receive messages, and publish their bookmarks. Users can also publish in forums on the site, post comments, and create bookmarks.

Membership and/or/registration may be required to author a story. Such membership may be free, and require certain personal information, or may be created by payment of a membership fee, for example. Once a member, users may create multiple stories, for example. Members may also create a group story and invite other members or users to join in the development of the story.

The web site may include any number of different web pages, including but not limited to the following: a front (or “landing”) page; a search results page; an account landing page; and a screening window page.

Via the account landing page, the user is able to perform actions such as: set options for the user's account; update the user's profile; customize the landing page and/or the account landing page; post information; perform instant messaging/chat with other users who are logged in; view information related to bookmarks the user has added; view information regarding the user's friends/connections; view information related to the user's activities; and/or interact with others and/or software for transferring information.

Advertising may be integrated into the site in any number of different ways. As one example, each or any of the pages in the web site may include banner advertisements. Alternatively, video advertisements may be played, and/or be inserted periodically.

The components in the web site system 910 (web server module 912, web application module 914, video server 918) may be implemented across one or more computing devices (such as, for example, server computers), in any combination.

The database 916 in the web site system 910 may be or include one or more relational databases, one or more hierarchical databases, one or more object-oriented databases, one or more flat files, one or more structured files, and/or one or more other files for storing data in an organized/accessible fashion. The database 916 may be spread across any number of computer-readable storage media. The database 916 may be managed by one or more database management systems in the web site system 910, which may be based on technologies such as Microsoft SQL Server, MySQL, PostgreSQL, Oracle Relational Database Management System (RDBMS), a NoSQL database technology, and/or any other appropriate technologies and/or combinations of appropriate technologies. The database 916 in the web site system 910 may store information related to the web site provided by the web site system 910, including but not limited to any or all information described herein as necessary to provide the features offered by the web site.

The web server module 912 implements the Hypertext Transfer Protocol (HTTP). The web server module 912 may be, for example, an Apache web server, Internet Information Services (IIS) web server, nginx web server, and/or any other appropriate web server program. The web server module 912 may communicate HyperText Markup Language (HTML) pages, handle HTTP requests, handle Simple Object Access Protocol (SOAP) requests (including SOAP requests over HTTP), and/or perform other related functionality.

The web application module 914 may be implemented using technologies such as PHP: Hypertext Preprocessor (PHP), Active Server Pages (ASP), Java Server Pages (JSP), Zend, Python, Zope, Ruby on Rails, Asynchronous JavaScript and XML (Ajax), and/or any other appropriate technology for implementing server-side web application functionality. In various implementations, the web application module 914 may be executed in an application server (not depicted in FIG. 97) in the web site system 910 that interfaces with the web server module 912, and/or may be executed as one or more modules within the web server module 912 or as extensions to the web server module 912. The web pages generated by the web application module 914 (in conjunction with the web server module 912) may be defined using technologies such as HTML (including HTML5), eXtensible HyperText Markup Language (XHMTL), Cascading Style Sheets, Javascript, and/or any other appropriate technology.

Alternatively or additionally, the web site system 910 may include one or more other modules (not depicted) for handling other aspects of the web site provided by the web site system 910.

The web browser module 922 in the computing device 920 may include and/or communicate with one or more sub-modules that perform functionality such as rendering HTML, rendering raster and/or vector graphics, executing JavaScript, decoding and rendering video data, and/or other functionality. Alternatively or additionally, the web browser module 922 may implement Rich Internet Application (RIA) and/or multimedia technologies such as Adobe Flash, Microsoft Silverlight, and/or other technologies, for displaying video. The web browser module 922 may implement RIA and/or multimedia technologies using one or web browser plug-in modules (such as, for example, an Adobe Flash or Microsoft Silverlight plugin), and/or using one or more sub-modules within the web browser module 922 itself. The web browser module 922 may display data on one or more display devices (not depicted) that are included in or connected to the computing device 920, such as a liquid crystal display (LCD) display or monitor. The computing device 920 may receive input from the user of the computing device 920 from input devices (not depicted) that are included in or connected to the computing device 920, such as a keyboard, a mouse, or a touch screen, and provide data that indicates the input to the web browser module 922.

Although the example architecture of FIG. 9 illustrates a single computing device, this is done for convenience in description, and it should be understood that the architecture of FIG. 9 in may include, mutatis mutandis, any number of computing devices with the same or similar characteristics as the described computing device.

Although the methods and features are described herein with reference to the example architecture of FIG. 9, the methods and features described herein may be performed, mutatis mutandis, using any appropriate architecture and/or computing environment. Alternatively or additionally, although examples are provided herein in terms of web pages generated by the web site system 910, it should be understood that the features described herein may also be implemented using specific-purpose client/server applications. For example, each or any of the features described herein with respect to the web pages in the interactive web site may be provided in one or more specific-purpose applications. For example, the features described herein may be implemented in mobile applications for Apple iOS, Android, or Windows Mobile platforms, and/or in client application for Windows, Linux, or other platforms, and/or any other appropriate computing platform.

For convenience in description, the modules (web server module 912, web application module 914, web browser module 922 and video server 918) shown in FIG. 9 are described herein as performing various actions. However, it should be understood that the actions described herein as performed by these modules are in actuality performed by hardware/circuitry (i.e., processors, network interfaces, memory devices, data storage devices, input devices, and/or display devices) in the electronic devices where the modules are stored/executed.

As used herein, the term “processor” broadly refers to and is not limited to a single- or multi-core central processing unit (CPU), a special purpose processor, a conventional processor, a Graphics Processing Unit (GPU), a digital signal processor (DSP), a plurality of microprocessors, one or more microprocessors in association with a DSP core, a controller, a microcontroller, one or more Application Specific Integrated Circuits (ASICs), one or more Field Programmable Gate Array (FPGA) circuits, any other type of integrated circuit (IC), a system-on-a-chip (SOC), and/or a state machine.

As used to herein, the term “computer-readable medium” broadly refers to and is not limited to a register, a cache memory, a ROM, a semiconductor memory device (such as a D-RAM, S-RAM, or other RAM), a magnetic medium such as a flash memory, a hard disk, a magneto-optical medium, an optical medium such as a CD-ROM, a DVDs, or BD, or other type of device for electronic data storage.

Although features are described herein as being performed in a computing device, the features described herein may also be implemented, mutatis mutandis, on a desktop computer, a laptop computer, a netbook, a cellular phone, a personal digital assistant (PDA), or any other appropriate type of tablet computing device or data processing device.

Although features and elements are described above in particular combinations, each feature or element can be used alone or in any combination with or without the other features and elements. For example, each feature or element as described above may be used alone without the other features and elements or in various combinations with or without other features and elements. Sub-elements of the methods and features described above may be performed in any arbitrary order (including concurrently), in any combination or sub-combination.

Although the invention has been described and pictured in an exemplary form with a certain degree of particularity, it is understood that the present disclosure of the exemplary form has been made by way of example, and that numerous changes in the details of construction and combination and arrangement of parts and steps may be made without departing from the spirit and scope of the invention as set forth in the claims hereinafter.

What is claimed is:

1. A computer-readable medium having processor-executable instructions stored thereon which, when executed by at least one processor, will cause the at least one processor to perform a method for creating a story based on input from a user, the method comprising:
storing video data in a memory device, wherein the video data includes:
a plurality of video data segments that make up a video, wherein each of the video data segments includes a plurality of frames and corresponding audio data, the video data segments classified according to the type of video data segment;
data that indicates a relationship based on the type of video segments in the story, wherein each of the video data segments has a position in the sequence;
storing the story results data in the memory device, wherein the story results data includes a story that is the video data segments appended in the selected order;
displaying, via a display device, a video display area, wherein the video display area includes:
a plurality of video data segment icons,
wherein each of the video data segment icons corresponds to a video data segment of the video data segments, and
wherein each of the video data segment icons includes a frame from the video data segment to which the video data segment icon corresponds; and
a plurality of sequence position icons, wherein each of the sequence position icons corresponds to a position in the sequence;
receiving user input data from the user via an input device,
wherein the user input data includes a plurality of drag and drop operations,
wherein each of the drag and drop operations indicates a drag and drop operation from a source video data segment icon of the video data segment icons onto a target sequence position icon of the sequence position icons;
for each of the drag and drop operations,
determining whether the position in the sequence of the video data segment to which the source video data segment icon corresponds is the same as the position in the sequence to which the target sequence position icon corresponds, and
when the position in the sequence of the video data segment to which the source video data segment icon corresponds is the same as the position in the sequence to which the target sequence position icon corresponds, updating the results data to include a story that is the video data segments appended in the selected order based on the position in the sequence of the video data segment to which the source video data segment icon corresponds; and
outputting the story.

2. The computer-readable medium of claim 1, wherein the method further comprises:
displaying, via the display device, the story.

3. The computer-readable medium of claim 1, wherein the method further comprises:
receiving a second user input data that indicates that a video data segment icon of the video data segment icons has been selected to be filled by a certain type of video data segment; and
in response to the second user input data, allowing the selected type of video data segment to fill the position in the sequence to which the selected video data segment icon corresponds.

4. The computer-readable medium of claim 1, wherein the video is a music video.

5. The computer-readable medium of claim 1, wherein the video is a feature-length film, a documentary video, or a commercial video.

6. The computer readable medium of claim 1, wherein at least one of the plurality of video segments is a PLAYER video segment.

7. The computer readable medium of claim 1, wherein at least one of the plurality of video segments is a STAR video segment.

8. The computer readable medium of claim 1 further comprising limiting the proximity of at least one of the plurality of video segments to at least one other of the plurality of video segments based on the type of the at least one of the plurality of video segments and the type of at least one other of the plurality of video segments.

9. A method for creating a story based on input from a user, the method comprising:
storing video data in a memory device, wherein the video data includes:
a plurality of video data segments that make up a video, wherein each of the video data segments includes a plurality of frames and corresponding audio data, the video data segments classified according to the type of video data segment;
data that indicates a relationship based on the type of video segments in the story, wherein each of the video data segments has a position in the sequence;
storing the story results data in the memory device, wherein the story results data includes a story that is the video data segments appended in the selected order;
displaying, via a display device, a video display area, wherein the video display area includes:
a plurality of video data segment icons,
wherein each of the video data segment icons corresponds to a video data segment of the video data segments, and
wherein each of the video data segment icons includes a frame from the video data segment to which the video data segment icon corresponds; and
a plurality of sequence position icons, wherein each of the sequence position icons corresponds to a position in the sequence;
receiving user input data from the user via an input device,
wherein the user input data includes a plurality of drag and drop operations,
wherein each of the drag and drop operations indicates a drag and drop operation from a source video data segment icon of the video data segment icons onto a target sequence position icon of the sequence position icons;
for each of the drag and drop operations,
determining whether the position in the sequence of the video data segment to which the source video data segment icon corresponds is the same as the position in the sequence to which the target sequence position icon corresponds, and
when the position in the sequence of the video data segment to which the source video data segment icon corresponds is the same as the position in the sequence to which the target sequence position icon corresponds, updating the results data to include a story that is the video data segments appended in the selected order based on the position in the sequence of the video data segment to which the source video data segment icon corresponds; and
outputting the story.

10. The method of claim 9, wherein the method further comprises:
displaying, via the display device, the story.

11. The method of claim 9, wherein the method further comprises:
receiving a second user input data that indicates that a video data segment icon of the video data segment icons has been selected to be filled by a certain type of video data segment; and
in response to the second user input data, allowing the selected type of video data segment to fill the position in the sequence to which the selected video data segment icon corresponds.

12. The method of claim 9, wherein at least one of the plurality of video segments is a PLAYER video segment.

13. The method of claim 9, wherein at least one of the plurality of video segments is a STAR video segment.

14. The method of claim 9 further comprising limiting the proximity of at least one of the plurality of video segments to at least one other of the plurality of video segments based on the type of the at least one of the plurality of video segments and the type of at least one other of the plurality of video segments.

15. The method of claim 9, wherein the video is a music video.

16. The method of claim 9, wherein the video is a feature-length film, a documentary video, or a commercial video.

17. A computing device for creating a video story based on input from a user, the computing device comprising:
a memory device configured to store data that represents a plurality of video data segments that make up a video and data that indicates an ordered sequence of the video data segments in the video, the video data segments classified according to the type of video data segment;
a processor configured:
to display, via a display device, a video display area that includes information related to the video segments; and
to receive, via an input device, user input data from the user, wherein the user input data indicates positions of the video data segments in the sequence;
to update results data to include a story that is the video data segments appended in the selected order based on the position in the sequence of the video data segment to which the source video data segment icon corresponds; and
a communication interface to output the story.

18. The computing device of claim 17, wherein the processor is further configured to display, via the display device, the story

19. The computing device of claim 17, wherein the video is a music video, a feature-length film, a documentary video, or a commercial video.

20. The computing device of claim 17 wherein the proximity of at least one of the plurality of video segments to at least one other of the plurality of video segments is limited based on the type of the at least one of the plurality of video segments and the type of at least one other of the plurality of video segments.
